(19) United States
(12) Patent Application Publication
(10) Pub. No.: US 2010/0089360 A1
(43) Pub. Date: Apr. 15, 2010

(54) SYSTEM, DEVICE AND METHOD FOR OPERATION OF INTERNAL COMBUSTION ENGINE

(76) Inventors: Zion Badash, Savyon (IL); Ilan Saady, Hod Hasharon (IL); Lior De-Nur, Herzlia (IL)

Correspondence Address: Pearl Cohen Zedek Latzer, LLP, 1500 Broadway, 12th Floor, New York, NY, 10036, US

(21) Appl. No.: 12/596,174

(22) PCT Filed: Apr. 16, 2007
(86) PCT No.: PCT/IL2007/000479

§ 371 Date: Oct. 28, 2009

(51) Int. Cl. F02M 27/00; F02M 35/00; B01D 39/10

(52) U.S. Cl. 123/198 E; 422/306

(57) ABSTRACT

The present invention provides an air supply assembly for providing air to a combustion engine, the air supply assembly comprising an air inlet opening; an air outlet opening; and a metal element positioned in an air flow path between the air inlet opening and air outlet opening, wherein, when air which flowed through the metal element is used for combustion in the combustion engine, the fuel consumption of the combustion engine is reduced and/or the air pollution created by the combustion engine is reduced. The present invention also provides a method for reducing fuel consumption of a combustion engine and a method for reducing air pollution created by a combustion engine, the method comprising passing air through a metal element; and using the air for combustion in the combustion engine

### BACKGROUND OF THE INVENTION

Internal combustion engines are known for a very long true. Efforts were made along the time to improve the efficiency of conversion of the energy in the fuel to mechanical energy, as well as to reduce the amount of pollution produced during their operation. Despite great progress that was made along the years, the efficiency of conversion and the amount of pollution still need improvement. An internal combustion engine may, schematically, comprise several main units, as depicted in FIG. 1, which is schematic illustration of an internal combustion engine system. Air may be supplied via air supply unit 12; fuel may be supplied via fuel supply unit 14. The air and fuel may be mixed in a mixing unit 16 and supplied to power unit 18, where the mixture is ignited or otherwise caused to explode and thus transform the inherent energy into mechanical energy, which may be outputted from the engine to any desired power consumer. Additionally, exhaust gases are outputted from the engine.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereat may best be understood by reference to the following detailed description when read with the accompanying drawings in which:

FIG. 1 is a schematic illustration of an internal combustion engine system;

FIG. 2 is a schematic block diagram illustration of an internal combustion engine system according to some embodiments of the present invention;

FIG. 3 is a schematic illustration of an opened position of air supply assembly for supplying air for combustion in a combustion engine according to some embodiments of the present invention;

FIG. 4 is an exemplary schematic illustration of a metal element which may be included in air supply assembly according to some embodiments of the present invention; and

FIG. 5 is a schematic flow diagram illustrating the method of operation of an internal combustion engine for reducing air pollution created by the combustion engine and/or reducing fuel consumption of the combustion engine according to some embodiments of the present invention.

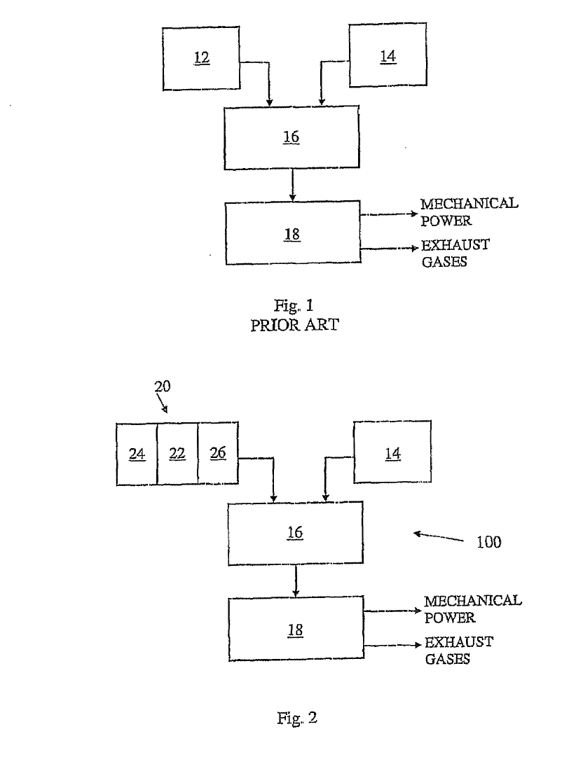

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

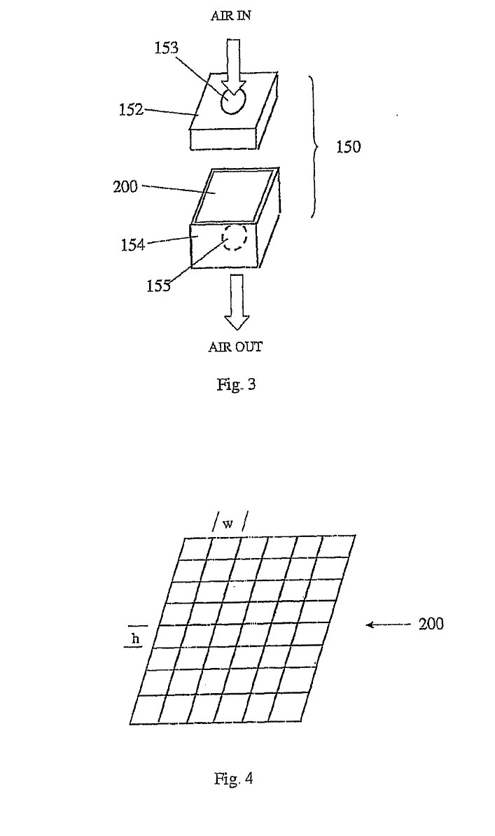

The inventors of the present invention have found, during research of new systems and methods for improved operation of internal combustion engine, that by placing a metal element in the course of air into the combustion engine so that the air flows over the material of the metal element, the efficiency of the engine and the output power of the engine are dramatically increased while the amount of pollution exhausted from the engine is dramatically reduced. Metal element 200 (shown in FIG. 3) or its equivalent replacement may be made of various kinds of metals, such as copper, with or without thin coating of other material such as silver, gold and the like. Attention is made now to FIG. 2, which is a schematic block diagram illustration of an internal combustion engine system 100 according to some embodiments of the present invention. Internal combustion engine system 100 may comprise air supply assembly 20, fuel supply unit 14 and a mixing unit 16 which may receive the air and the fuel in order to mix them and to provide an air-fuel mixture to power unit 18. Air supply assembly 20 may comprise air inlet portion 24, air outlet portion 26 and metal element 22. Metal element 22 may be positioned in an ah flow path between air inlet portion 24 and air outlet portion 26. Air inlet portion 24 and/or air outlet portion 26 may include an air duct, an air duct with air filter; or the like, Metal element 22 may include, for example, a metal mesh and/or metal wires and/or metal layers, so that air may flow and/or pass through metal element 22.

Fuel supply unit 14 may be a fuel tank with or without a fuel pump and or with or without fuel flow regulator, or the like. Mixing unit 16 may be, for example, a carburetor, an air-fuel atomizer, and the like. Air may flow and/or pass through air supply assembly 20 into mixing unit 16. Mixing unit 16 may mix air and fuel which may be received, for example, from air supply assembly 20 and fuel supply unit 14, respectively, Mixing unit 16 may provide the mixture of air and fuel to power unit 18, which may be, according to some embodiments, an internal combustion engine. Power unit 18 may use the mixture of air and fuel for producing energy, for example, by combustion of the mixture. The produced energy may be, for example, mechanical power for vehicles. As a result of the energy production process a polluting gas, e.g., exhaust gas may be discharged from combustion engine system 100 to the environment. When air which flowed and/or passed through metal element 22 is mixed with fuel by mixing unit 16 and used for energy production by power unit 18, e.g., in a combustion process, the pollution level of the exhausted gas may be reduced. In addition, power unit 18 may need less fuel in order to produce the same amount of energy, e.g., the fuel consumption may be reduced. Attention is now made to FIG. 3, which is a schematic illustration of air filter assembly 150 of an internal combustion engine, including a metal element 200, according to some embodiments of the present invention. Air filter assembly 150 is drawn in “opened” position for the clarity of the illustration. Typically, air filter assembly 150 is closed so that metal element 200 is enclosed within the assembly. Air filter assembly 150 may comprise an inlet portion 152 with air inlet opening 153 and an air outlet portion 154 with air outlet 155. Metal element 200 made and installed according to embodiments of the present invention may be positioned in air filter assembly 150 as shown in FIG. 3 so that the air flowing and/or passing trough air filter assembly 150 flows substantially perpendicularly trough metal element 200. It should be apparent for a person skilled in the art that metal element 200 may be placed in the air flow route in one or more of many different manners and different angles with respect to the direction of the air-flow. Metal element 200 may include a metal mesh and/or metal wires and/or metal layers in any suitable arrangement, so that air may flow and/or pass through metal element 200. For example, metal element 200 may include one or more thin plates properly placed in the air-flow route and substantially parallel to the air-flow direction so that its surface is exposed to the flow of the air with minimal disturbances to the air-flow. Although this invention is not limited in this respect, in some embodiments of the present invention the material or composition of materials from which metal element 200 may be made, may include a surface being rich with oxygen molecules that may be easily drifted by the flow of air toward the engine. This may enrich with oxygen the air being used for combustion by system 100 (shown in FIG. 2), which may help reducing the air pollution created by system 100 in the combustion process. It may also help, for example, in reducing the fuel consumption of system 100. Attention is now made to FIG. 4, which is an exemplary schematic illustration of metal element 200 in details. Although the invention is not limited to this example, metal element 200 may be a mesh made from crisscrossed metal wires as shown in FIG. 4, forming between them a general form of a rectangular with a first dimension “h” and a second dimension “w”. The first and second dimensions “h” and “w” may be, in some cases equal, forming square spaces between the wires. It should be noted that the form of the spaces between the wires may be of any desired form, such as hexagon, heptagon, octagon, circle and the like. Subsequently, the form of the mesh forming these spaces may be any, as long as a negligible interrupt to the flow of air is caused and a substantially high amount of flowing air is exposed to contact with the metal mesh. Thus, the metal elements 200 of FIGS. 3 and 4 are only schematic and for the purpose of example.

Metal element 200 may be made of various materials or combination of materials, and may be made in the form of mesh or, for example, perforated plate to enlarge surface area of the metal element that increases the influence on the air flow. Metal element 200 may include, for example, solid copper, solid copper laminated with gold with thickness of; for example, 80 micrometers, solid copper with presence of solid bulk of gold or all the above mentioned in other physical forms similar to mesh.

The inventors of the present invention have discovered that when a metal element is inserted into the air flow path of an internal combustion engine, so that the air consumed by the engine flows over and/or passes through the metal element, the performance of the engine, with respect to efficiency of conversion of the chemical internal energy stored in the fuel to mechanical energy grows higher and the amount of polluted gases in the exhausted gases grows much lower when certain metal, or combination of certain metals are used in the metal element. The performance of an internal combustion engine according to embodiments of the present invention was measured in different conditions as regarding to the type of engine, for example, gasoline or diesel fuel, the type of gearbox for example, manual or automatic, and various engine volumes, for example, 1896 cc, 2446 cc, 2300 cc, 3136 cc, 1868 cc and 1597 cc. The parameters which were measured include average fuel consumption per traveled distance, change in output available power of the engine and amount of exhaust gases in idle revolutions and in 2500 rounds-per-minute (RPM). The measured results of the performance of an internal combustion engine system 100 according to some embodiments of the present invention are exemplified in Tables 1, 2 and 3 below.

Table 1 presents the results of an experiment done by the inventors of the present invention. Table 1 compares the fuel consumption, available power of the engine and pollution, all these with and without metal element 200, and illustrates the improvements in these parameters when metal element 200 is installed in the vehicle.

The fuel consumption was measured as an average over a 500 km trip. The power of the engine was measured by an engine dynamometer. The pollution was measured by two different methods, for diesel engines and for gasoline engines. For diesel engines, the pollution was measured by examining the turbidity of the exhaust gases. The results presented in Table 1 are numbers representing the gas turbidity. The gas turbidity was examined by a device which measures the density or opacity of the smoke content in the exhaust gases from 0 to 100 Hartridge smoke units (“HSU”). The Israeli “Hartridge Smokemeter Standard” permits up to 30 HSU for a heavy vehicle and up to 40 HSU for a light vehicle. For gasoline engine, the pollution was measured by examining the percentage of polluting gases in the exhaust gases. The results presented in Table 1 are the CO percentage in the exhaust gases. According to the Israeli standard which leans on the European standard Euro 4, in 2300-2800 RPM, up to 0.3% of CO in the exhaust gases are permitted. The results presented in Table 1 indicate substantial improvement in the three parameters of fuel consumption, power of the engine and pollution. In Table 1, the improvement in average fuel consumption ranges from approximately 28% to approximately 50.6% in number of kilometers traveled on a litre of fuel, the increase in available power ranges from approximately 28.9% to approximately 34.8% and the improvement in pollution ranges from approximately 65% and above in gasoline fuel engines in 2500 RPM and from approximately 45% to approximately 62.5% in diesel fuel engines. It should be noted that the performance presented in Table 1 reflects results achieved using a metal mesh that was installed in the air filter compartment or close to it, having the outer dimensions of substantially the cross section of the air filter compartment substantially perpendicular to the air flow direction, as depicted in FIG. 3.

TABLE 1

| Engine | | | Fuel Consumption | | Added | Pollution in Exhaust Gases | | Pollution in Exhaust Gases | |
|---|---|---|---|---|---|---|---|---|---|
| Volume | Fuel | Gearbox | [km/liter] | | Power | [idle revolutions] | | [2500 RPM] | |
| [cc] | Type | Type | W/O | W % change | [%] | W/O | W % change | W/O | W % change |
| 1896 | Diesel | Auto. | 15.1 | 21.3 | 28.9% | N/A | N/A | 40 HSU | 15 HSU −62.5% |
| | | | | 41% | | | | | |
| 2446 | Diesel | Manual | 9.2 | 12.3 | 34.8% | N/A | N/A | 39 HSU | 18 HSU −53.8% |
| | | | | 33.6% | | | | | |
| 2300 | Diesel | Auto. | 10.2 | 14.1 | 30.1% | N/A | N/A | 45 HSU | 25 HSU 45% |
| | | | | 38.2% | | | | | |
| 3136 | Gasoline | Auto. | 8.3 | 12.5 | 30.4% | 0.3% CO in | 0% CO in | 0.3% CO in | 0% CO in |
| | | | | 50.6% | | ex. gases | ex. gases | ex. gases | ex. gases |
| 1868 | Gasoline | Auto | 10.4 | 13.9 | 34% | 0.4% CO in | 0% CO in | 0.3% CO in | 0% CO in |
| | | | | 33.6% | | ex. gases | ex. gases | ex. gases | ex. gases |
| 1597 | Gasoline | Manual | 14.3 | 19.2 | 29% | 0.3% CO in | 0.007% CO in | 0.2% CO in | 0.07% CO in |
| | | | | 34.2% | | ex. gases | ex. gases −97% | ex. gases | ex. gases −65% |
| 1400 | Gasoline | ? | 17.1 | 22.32 | 28% | 0.2% CO in | 0% CO in | 0.2% CO in | 0% CO in |
| | | | | 30.53 | | ex. gases | ex. gases | ex. gases | ex. gases |
| 1500 | Gasoline | ? | 12.6 | 16.96 | 30.4% | 0.4% CO in | 0.009% CO in | 0.3% CO in | 0.08% CO in |
| | | | | 34.60% | | ex. gases | ex. gases −97% | ex. gases | ex. gases −74% |
| 3100 | Gasoline | ? | 9.8 | 12.92 | 30% | 0.3% CO in | 0% CO in | 0.3% CO in | 0% CO in |
| | | | | 31.84 | | ex. gases | ex. gases −97% | ex. gases | ex. gases |
| 2000 | Gasoline | ? | 10.54 | 14.93 | 30% | 0.4% CO in | 0% CO in | 0.3% CO in | 0% CO in |
| | | | | 41.65% | | ex. gases | ex. gases | ex. gases | ex. gases |
| 1900 | diesel | ? | 14 | 19 | 31% | N/A | N/A | 42 HSU | 16 HSU −68% |
| | | | | 35.71% | | | | | |
| 1600 | Gasoline | ? | 14.3 | 19.2 | 28% | 0.3% CO in | 0% CO in | 0.3% CO in | 0% CO in |
| | | | | 34.27% | | ex. gases | ex. gases | ex. gases | ex. gases |
| 3100 | Gasoline | ? | 9.3 | 12.42 | 29% | 0.4% CO in | 0% CO in | 0.3% CO in | 0.07% CO in |
| | | | | 33.55% | | ex. gases | ex. gases | ex. gases | ex. Gases −67% |
| 1896 | diesel | ? | 15.1 | 21.3 | 30% | N/A | N/A | 40 HSU | 15 HSU −62.5% |
| | | | | 41.06% | | | | | |
| 2446 | diesel | ? | 9.2 | 12.3 | 34.8% | N/A | N/A | 39 HSU | 18 HSU −53.8% |
| | | | | 33.70% | | | | | |
| 2400 | diesel | ? | 10.2 | 14.1 | 33% | N/A | N/A | 40 HSU | 16 HSU −60% |
| | | | | 38.24% | | | | | |
| 1868 | Gasoline | ? | 10.4 | 13.9 | 29% | 0.4% CO in | 0.009% CO in | 0.3% CO in | 0.07% CO in |
| | | | | 33.65% | | ex. gases | ex. gases −97% | ex. gases | ex gases −77% |
| 1800 | Gasoline | ? | 9.8 | 12.54 | | 0.3% CO in | 0% CO in | 0.3% CO in | 0% CO in |
| | | | | 27.96% | 28% | ex gases | ex. gases | ex. gases | ex. gases |
| 1500 | Gasoline | ? | 14.1 | 18.41 | 29.6% | 0.4% CO in | 0% CO in | 0.3% CO in | 0% CO in |
| | | | | 30.57% | | ex gases | ex. gases | ex. gases | ex gases |
| 1350 | Gasoline | ? | 12.6 | 16.25 | 30% | 0.3% CO in | 0% CO in | 0.3% CO in | 0.008% CO in |
| | | | | 28.97% | | ex. gases | ex. gases | ex. gases | ex. Gases −97% |
| 1900 | diesel | ? | 18 | 23.5 | 30.4% | N/A | N/A | 40 HSU | 16 HSU −60% |
| | | | | 30.56% | | | | | |
| 1600 | Gasoline | ? | 12.7 | 16.45 | 28.7% | 0.2% CO in | 0% CO in | 0.2% CO in | 0% CO in |
| | | | | 29.53% | | ex. gases | ex. gases | ex. gases | ex. gases |

Table 2 presents the results of an experiment done by the inventors of the present invention. Table 2 compares the fuel consumption with and without metal element 200 in different car models and illustrates the improvements in the fuel consumption when metal element 200 is installed in the vehicle. As indicated in Table 2, in this experiment the inventors used as metal element 200 different copper elements, for example meshes and perforated plates of different kinds. The results presented in Table 2 indicate an improvement of approximately 34 percent in number of kilometers traveled on a litre of fuel.

Table 3 presents the results of an experiment done by the inventors of the present invention. Table 3 compares the fuel consumption with and without metal element 200 in different motorcycles models and illustrates the improvements in the fuel consumption when metal element 200 is installed in the motorcycle. As indicated in Table 3, in this experiment the inventors used as metal element 200 a copper mesh with dimensions of approximately 8 cm×10 cm, which weighs approximately 11gr. The results presented in Table 3 indicate an improvement of approximately 32 percent in number of kilometers traveled on a litre of fuel.

According to the present invention, the measure of reduction in number of kilometers traveled on a litre of fuel may range from approximately 25% to approximately 50.6%.

In cars where a computer is used for controlling fuel/air supply to the engine, the computer may be reset, for example, upon installation of metal element 200, in order that effects of the present invention, e.g., reduced air consumption and/or reduced pollution, may be felt sooner after the installation of metal element 200 according to the present invention. In case the computer is not reset, it may take time for the computer to adjust to the amounts of fuel needed by the engine over several kilometers traveled, for example, several hundreds of kilometers traveled.

TABLE 2

| Fuel | Fuel | | | Fuel | Fuel | Fuel | Fuel | | | |
|---|---|---|---|---|---|---|---|---|---|---|
| Consumption | Consumption | | Device | Consumption | Consumption | Consumption | Consumption | Distance | Car | |
| Improvement | Improvement | Fuel | (Copper | With Device | W/O Device | With Device | W/O Device | Traveled | Speed | Car |
| In Km/Litre | In Litre | Type | Element) | [Km/Litre] | [Km/Litre] | [litre] | [litre] | [km] | [km/h] | model |
| 30.00% | 26.90% | 95 | Mesh | 16.64 | 12.80 | 5.54 | 7.03 | 90 | 80 | Hyundai |
| | | | 12 cm × 17 cm | | | | | | | Accent |
| | | | 20 gr | | | | | | | |
| 30.53% | 30.36% | 95 | Perforated | 22.32 | 17.1 | 4.48 | 5.84 | 100 | 80 | Fiat Uno |
| | | | Plate | | | | | | | 1400 cc |
| | | | 10 cm × 20 cm | | | | | | | |
| | | | 15 gr | | | | | | | |
| 34.60% | 35.32% | 95 | Mesh | 16.96 | 12.6 | 5.86 | 7.93 | 100 | 80 | Hyundai |
| | | | 12 cm × 15 cm | | | | | | | Accent |
| | | | 18 gr | | | | | | | 1500 cc |
| 33.43% | 33.09% | 95 | Perforated | 17.88 | 13.4 | 5.59 | 7.44 | 100 | 80 | Mazda 6 |
| | | Lead | Plate | | | | | | | |
| | | Free | 11 cm × 16 cm | | | | | | | |
| | | | 13 gr | | | | | | | |
| 39.08% | 39.15% | 95 | Mesh | 15.16 | 10.9 | 6.59 | 9.17 | 100 | 80 | Ford |
| | | Lead | 10 cm × 16 cm | | | | | | | Mondeo |
| | | Free | 19 gr | | | | | | | |
| 31.84% | 31.90% | 95 | Perforated | 12.92 | 9.8 | 9.28 | 12.24 | 120 | 80 | Chevrolet |
| | | Lead | Plate | | | | | | | 3100 |
| | | Free | 10 cm × 20 cm | | | | | | | |
| | | | 15 gr | | | | | | | |
| 30.31% | 56.30% | 95 | Perforated | 20.98 | 16.1 | 4.76 | 7.44 | 100 | 80 | Honda |
| | | Lead | Plate | | | | | | | Civic |
| | | Free | 11 cm × 16 cm | | | | | | | |
| | | | 13 gr | | | | | | | |
| 33.63% | 33.53% | 95 | Mesh | 15.1 | 11.3 | 6.62 | 8.84 | 100 | 80 | Ford |
| | | Lead | 10 cm × 16 cm | | | | | | | Sierra |
| | | Free | 19 gr | | | | | | | |
| 32.93% | 33.06% | 95 | Perforated | 16.35 | 12.3 | 6.11 | 8.13 | 100 | 80 | Hyundai |
| | | Lead | Plate | | | | | | | Accent |
| | | Free | 10 cm × 20 cm | | | | | | | |
| | | | 15 gr | | | | | | | |
| 41.65% | 36.61% | 95 | Perforated | 14.93 | 10.54 | 11.2 | 15.3 | 158.2 | 110 | Ford |
| | | Lead | Plate | | | | | | | Mondeo |
| | | Free | 10 cm × 20 cm | | | | | | | 2000 |
| | | | 15 gr | | | | | | | |
| 35.71% | 37.50% | diesel | Mesh | 19 | 14 | 8 | 11 | 160 | 100 | VW |
| | | | 12 cm × 17 cm | | | | | | | Passat |
| | | | 20 gr | | | | | | | 1900 |
| 34.27% | 37.50% | 95 | Mesh | 19.2 | 14.3 | 8 | 11 | 160 | 100 | Mazda |
| | | Lead | 12 cm × 15 cm | | | | | | | 323 |
| | | Free | 18 gr | | | | | | | 1600 |
| 34.38% | 34.41% | 95 | Mesh | 18.49 | 13.76 | 10.81 | 14.53 | 200 | 105 | Mazda 6 |
| | | | 12 cm × 17 cm | | | | | | | |
| | | | 20 gr | | | | | | | |
| 31.99% | 31.98% | 95 | Perforated | 17.33 | 13.13 | 5.19 | 6.85 | 90 | 105 | Mazda 6 |
| | | Lead | Plate | | | | | | | |
| | | Free | 11 cm × 16 cm | | | | | | | |
| | | | 13 gr | | | | | | | |
| 33.55% | 33.39% | 95 | Mesh | 12.42 | 9.3 | 12.07 | 16.1 | 150 | 110 | Chevrolet |
| | | Lead | 14 cm × 19 cm | | | | | | | 3100 |
| | | Free | 25 gr | | | | | | | |
| 41.06% | 41.12% | diesel | Mesh | 21.3 | 15.1 | 12.67 | 17.88 | 270 | 100 | VW |
| | | | 10 cm × 16 cm | | | | | | | Passat |
| | | | 19 gr | | | | | | | 1896 |
| 33.70% | 33.37% | diesel | Mesh | 12.3 | 9.2 | 20.32 | 27.1 | 250 | 105 | Peugeot |
| | | | 15 cm × 10 cm | | | | | | | 2446 |
| | | | 18 gr | | | | | | | |
| 38.24% | 38.19% | diesel | Mesh | 14.1 | 10.2 | 8.51 | 11.76 | 120 | 110 | Hyundai |
| | | | 10 cm × 16 cm | | | | | | | 2400 |
| | | | 19 gr | | | | | | | |
| 34.27% | 34.21% | 95 | Perforated | 19.2 | 14.3 | 8.33 | 11.18 | 160 | 100 | 323 |
| | | | Plate | | | | | | | Mazda |
| | | | 10 cm × 20 cm | | | | | | | |
| | | | 15 gr | | | | | | | |
| 33.65% | 33.73% | 95 | Perforated | 13.9 | 10.4 | 14.38 | 19.23 | 200 | 100 | Peugeot |
| | | | Plate | | | | | | | 309 |
| | | | 10 cm × 30 cm | | | | | | | 1868 |
| | | | 15 gr | | | | | | | |
| 41.76% | 41.68% | 95 | Mesh | 12.9 | 9.1 | 7.75 | 10.98 | 100 | 105 | Hyundai |
| | | | 10 cm × 16 cm | | | | | | | |
| | | | 19 gr | | | | | | | |
| 27.96% | 27.98% | 95 | Mesh | 12.54 | 9.8 | 7.97 | 10.2 | 100 | 110 | Mazda |
| | | | 10 cm × 16 cm | | | | | | | 1800 |
| | | | 19 gr | | | | | | | |
| 30.57% | 31.05% | 95 | Mesh | 18.41 | 14.1 | 5.41 | 7.09 | 100 | 105 | Hyundai |
| | | | 12 cm × 17 cm | | | | | | | Accent |
| | | | 20 gr | | | | | | | 1500 |
| 28.97% | 28.86% | 95 | Mesh | 16.25 | 12.6 | 4.92 | 6.34 | 80 | 100 | Hyundai |
| | | | 12 cm × 15 cm | | | | | | | Getz |
| | | | 18 gr | | | | | | | 1350 cc |
| 30.56% | 30.65% | diesel | Perforated | 23.5 | 18 | 3.23 | 4.22 | 76 | 100 | VW |
| | | | Plate | | | | | | | Golf sdi |
| | | | 10 cm × 20 cm | | | | | | | 1900 |
| | | | 15 gr | | | | | | | |
| 29.53% | 29.64% | 95 | Mesh | 16.45 | 12.7 | 9.11 | 11.81 | 150 | 105 | Subaru |
| | | | 10 cm × 16 cm | | | | | | | Impreza |
| | | | 19 gr | | | | | | | 1600 cc |
| 34.00% | 34.10% | 95 | Mesh | 20.77 | 15.5 | 4.81 | 6.45 | 100 | 90 | Renault |
| | | | 14 cm × 18 cm | | | | | | | Clio b |
| | | | 25 gr | | | | | | | |
| 34.96% | 35.01% | 95 | Perforated | 18.22 | 13.5 | 12.34 | 16.66 | 225 | 105 | Mazda |
| | | | Plate | | | | | | | Lantis |
| | | | 10 cm × 20 cm | | | | | | | 1800 |
| | | | 15 gr | | | | | | | |
| 29.92% | 29.87% | 95 | Mesh | 15.72 | 12.1 | 6.36 | 8.26 | 100 | 110 | Hyundai |
| | | | 12 cm × 17 cm | | | | | | | Accent |
| | | | 20 gr | | | | | | | |
| 32.42% | 32.42% | 95 | Perforated | 21.32 | 16.1 | 5.86 | 7.76 | 125 | 105 | Fiat Uno |
| | | | Plate | | | | | | | 1400 cc |
| | | | 10 cm × 20 cm | | | | | | | |
| | | | 15 gr | | | | | | | |
| 33.00% | 33.07% | 95 | Mesh | 15.96 | 12 | 6.26 | 8.33 | 100 | 100 | Hyundai |
| | | | 12 cm × 15 cm | | | | | | | Accent |
| | | | 18 gr | | | | | | | 1500 cc |
| 28.96% | 29.32% | 95 | Mesh | 14.83 | 11.5 | 6.72 | 8.69 | 100 | 100 | Volvo |
| | | | 10 cm × 16 cm | | | | | | | 740 |
| | | | 19 gr | | | | | | | 2000 cc |
| 40.97% | 40.99% | 95 | Mesh | 14.52 | 10.3 | 6.88 | 9.7 | 100 | 110 | VW Golf |
| | | | 14 cm × 18 cm | | | | | | | 2000 cc |
| | | | 25 gr | | | | | | | |
| 33.00% | 33.55% | 95 | Perforated | 21.28 | 16 | 4.68 | 6.25 | 100 | 100 | Suzuki |
| | | | Plate | | | | | | | Swift |
| | | | 10 cm × 20 cm | | | | | | | |
| | | | 15 gr | | | | | | | |
| 34.38% | 34.42% | 95 | Mesh | 12.9 | 9.6 | 11.62 | 15.62 | 150 | 105 | Mazda |
| | | | 10 cm × 16 cm | | | | | | | mpv |
| | | | 19 gr | | | | | | | |
| 29.58% | 29.65% | 95 | Mesh | 9.2 | 7.1 | 10.86 | 14.08 | 100 | 100 | Chevrolet |
| | | | 14 cm × 18 cm | | | | | | | Astro |
| | | | 25 gr | | | | | | | 4300 cc |
| 32.97% | 33.01% | 95 | Mesh | 20.61 | 15.5 | 7.27 | 9.67 | 150 | 100 | Ford |
| | | | 10 cm × 16 cm | | | | | | | Focus |
| | | | 19 gr | | | | | | | 1600 |
| 30.79% | 32.00% | 95 | Perforated | 13.21 | 10.1 | 7.5 | 9.9 | 100 | 100 | Honda |
| | | | Plate | | | | | | | Accord v6 |
| | | | 10 cm × 20 cm | | | | | | | 3000 |
| | | | 15 gr | | | | | | | |
| 33.98% | 33.96% | 95 | Mesh | 16.48 | 12.3 | 9.1 | 12.19 | 150 | 110 | Toyota |
| | | | 10 cm × 16 cm | | | | | | | Avensis |
| | | | 19 gr | | | | | | | |
| 32.95% | 32.95% | 95 | Mesh | 16.22 | 12.2 | 6.16 | 8.19 | 100 | 100 | Honda |
| | | | 12 cm × 17 cm | | | | | | | Bravo v16 |
| | | | 20 gr | | | | | | | 1600 cc |
| 33.65% | 33.62% | 95 | Mesh | 13.9 | 10.4 | 11.51 | 15.38 | 160 | 100 | Honda |
| | | | 10 cm × 16 cm | | | | | | | Accord v6 |
| | | | 19 gr | | | | | | | 3000 |
| 43.37% | 43.43% | 95 | Mesh | 11.9 | 8.3 | 21 | 30.12 | 250 | 110 | Ford |
| | | | 14 cm × 18 cm | | | | | | | Mondeo |
| | | | 25 gr | | | | | | | 2000 |

TABLE 3
Measurements with Copper Mesh of 8 cm × 10 cm, 11 gr

| | | Fuel | Fuel | Fuel | Fuel | | | |
|---|---|---|---|---|---|---|---|---|
| | | Consumption | Consumption | Consumption | Consumption | Distance | | |
| Improvement | Improvement | With Device | W/O Device | With Device | W/O Device | Traveled | Motorcycle | |
| In Km/Litre | In Litre | [km/litre] | [km/litre] | [litre] | [litre] | [km] | MODEL | Manufacturer |
| 33.33% | 35.14% | 18 | 13.5 | 4.44 | 6 | 80 | CBR600F4 | HONDA |
| 25.00% | 25.00% | 25 | 20 | 3.2 | 4 | 80 | GS500E 2002 | SUZUKI |
| 33.33% | 32.50% | 20 | 15 | 4 | 5.3 | 80 | CBR600F2 | HONDA |
| 35.29% | 35.45% | 23 | 17 | 3.47 | 4.7 | 80 | CBR600RR | HONDA |
| 29.41% | 29.48% | 22 | 17 | 3.63 | 4.7 | 80 | ZZR-600 | KAWASAKI |
| 33.33% | 32.13% | 24 | 18 | 3.33 | 4.4 | 80 | ER5 1997 | KAWASAKI |
| 31.25% | 31.58% | 21 | 16 | 3.8 | 5 | 80 | GPZ500 | KAWASAKI |
| 31.82% | 30.91% | 29 | 22 | 2.75 | 3.6 | 80 | GS500 | SUZUKI |
| 30.00% | 30.29% | 26 | 20 | 3.07 | 4 | 80 | KLE500 | KAWASAKI |
| 33.33% | 32.50% | 20 | 15 | 4 | 5.3 | 80 | DR650SE | SUZUKI |
| 31.25% | 31.58% | 21 | 16 | 3.8 | 5 | 80 | XT500 1998 | YAMAHA |
| 32.00% | 32.23% | 33 | 25 | 2.42 | 3.2 | 80 | XR-250L 1994 | HONDA |
| 33.33% | 32.13% | 24 | 18 | 3.33 | 4.4 | 80 | XR-650L 1996 | HONDA |
| 40.00% | 40.11% | 14 | 10 | 5.71 | 8 | 80 | DRZ 400 | SUZUKI |
| 35.29% | 35.45% | 23 | 17 | 3.47 | 4.7 | 80 | XL1000V | HONDA |
| 33.33% | 32.00% | 16 | 12 | 5 | 6.6 | 80 | CBR F3 | HONDA |
| 30.43% | 31.58% | 30 | 23 | 2.66 | 3.5 | 80 | GN250 1996 | SUZUKI |
| 26.32% | 26.13% | 24 | 19 | 3.33 | 4.2 | 80 | R-6 2000 | YAMAHA |
| 33.33% | 32.50% | 20 | 15 | 4 | 5.3 | 80 | ZZR 1998 | KAWASKI |
| 31.82% | 30.91% | 29 | 22 | 2.75 | 3.6 | 80 | DRZ | SUZUKI |

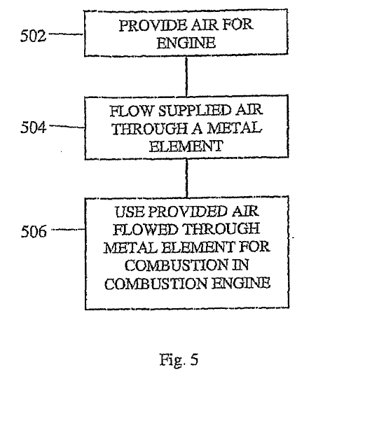

Attention is now made to FIG. 5, which is a schematic flow diagram illustrating the method of operation of an internal combustion engine for reducing air pollution created by the combustion engine and/or reducing fuel consumption of the combustion engine according to some embodiments of the present invention. Air to an internal combustion engine is provided to a system working according to some embodiments of the present invention (block 502). The provided air is forced to flow and/or pass thorough a metal element (block 504) and thus to come in contact with the outer surface of the metal element. The air that was flowed through the metal element is then used for combustion in the combustion engine (block 506).

While certain features of the invention have been illustrated and described herein, Many modifications, substitutions, changes, and equivalents will now occur to those of ordinary skill in the art. It is, therefore, to be understood that the appended claims are intended to cover all such modifications and changes as fall within the true spirit of the invention.

1. An air supply assembly for providing air to a combustion engine, said air supply assembly comprising:
an air inlet opening; an air outlet opening; and
a metal element positioned in an air flow path between said air inlet opening and air outlet opening,
wherein, when air which flowed through said metal element is used for combustion in said combustion engine, at least one of the following occurs: the fuel consumption of said combustion engine is reduced, the air pollution created by said combustion engine is reduced and the available power of the engine is increased.

2. (canceled)

3. An assembly according to claim 1, wherein said metal element comprises at least one of a list comprising copper, a metal mesh, gold lamination, metal wires, perforated plate and metal layers, wherein air is allowed to flow over at least some of said layers.

4-8. (canceled)

9. An assembly according to claim 1, wherein air which flows through said metal element drifts oxygen molecules from the surface of said metal element.

10. An assembly according to claim 1, wherein said reduction in fuel consumption ranges from approximately 25% to approximately 50.6% in number of kilometers traveled on a liter of fuel.

11. An assembly according to claim 1, wherein said reduction in air pollution created by said combustion engine ranges from 65% of CO in exhaust gases and above in gasoline fuel engines and from approximately 45% to approximately 62.5% of gas turbidity in diesel fuel engines in 2500 RPM.

12. (canceled)

13. An assembly according to claim 1 wherein said increase in available power of the engine ranges from approximately 28.9% to approximately 34.8%.

14-26. (canceled)

27. A method, the method comprising:
passing air through a metal element; and
using said air for combustion in said combustion engine.

28. A method according to claim 27, wherein when using said air for combustion in said combustion engine, at least one of the following occurs: the fuel consumption of said combustion engine is reduced, the air pollution created by said combustion engine is reduced and the available power of the engine is increased.

29. A method according to claim 27, wherein said metal element comprises at least one of a list comprising copper, a metal mesh, gold lamination, metal wires, perforated plate and metal layers, wherein air is allowed to flow over at least some of said layers.

30-34. (canceled)

35. A method according to claim 27, further comprising drifting oxygen molecules from the surface of said metal element by said passing air.

36. A method according to claim 28, wherein said reduction in fuel consumption ranges from approximately 25% to approximately 50.6% in number of kilometers traveled on a liter of fuel.

37. A method according to claim 28, wherein said reduction in air pollution created by said combustion engine ranges from 65% of CO in exhaust gases and above in gasoline fuel engines and from approximately 45% to approximately 62.5% of gas turbidity in diesel fuel engines in 2500 RPM.

38. (canceled)

39. A method according to claim 28, wherein said increase in available power of the engine ranges from approximately 28.9% to approximately 34.8%.

40-52. (canceled)
